(19) United States
(12) Patent Application Publication
(10) Pub. No.: US 2021/0039127 A1
(43) Pub. Date: Feb. 11, 2021

(54) CLEANING DEVICE AND CORRESPONDING METHOD

(71) Applicant: COROB S.P.A., San Felice Sul Panaro (IT)

(72) Inventors: Andrea Alvisi, Spilamberto (IT); Giorgio Manfredini, Riva del Garda (IT)

(21) Appl. No.: 16/965,640

(22) PCT Filed: Jan. 29, 2019
(86) PCT No.: PCT/IT2019/050021

§ 371 Date: Jul. 29, 2020

(30) Foreign Application Priority Data
Jan. 29, 2018 (IT) 102018000002124
Aug. 28, 2018 (IT) 102018000008206

(51) Int. Cl. B05B 15/55; B05B 15/52; B08B 3/12; B08B 1/00; B08B 7/04; B01F 13/10; B01F 15/00

(52) U.S. Cl. CPC B05B 15/55; B05B 15/52; B08B 3/12; B01F 2215/005; B08B 7/04; B01F 13/1055; B01F 15/00025; B08B 1/002

(57) ABSTRACT

Cleaning device to clean fluid product delivery elements (53), comprising a washing receptacle (11) provided with walls (12, 13) that define a container configured to be receive a washing fluid (100), and movement means (22, 25) configured to move the washing receptacle (11) between a cleaning position (C), in which the washing receptacle (11) is disposed in proximity to the delivery elements (53) to be cleaned in a position such that the delivery elements (53) are at least partly immersed in the washing fluid (100), and an inactive position (R), in which the washing receptacle (11) is distanced from the delivery elements (53).

### FIELD OF THE INVENTION

The present invention concerns a cleaning device, and a corresponding method, for cleaning one or more elements to deliver colorant fluid products. The invention also concerns a machine to deliver colorant fluid products which comprises the cleaning device.

### BACKGROUND OF THE INVENTION

Known machines for delivering colorants comprise at least one delivery head formed by a plurality of nozzles, each one configured to deliver a respective colorant.

With the term colorant, here and throughout the description and claims, we mean any fluid or semi-fluid product such as a paint, an ink, a base or pigmented dye, a paste, and any other similar or comparable product to those indicated above.

In known delivery heads, each nozzle normally comprises a pipe for the passage of the colorant that flows into an outlet hole, and a closing valve configured to selectively close the outlet hole so as to alternatively allow or prevent passage of the colorant.

Typical disadvantages of colorant delivery machines known in the state of the art are related to the fact that the nozzles can become obstructed or get dirty between one delivery cycle and the next.

At the end of a delivery cycle, it can happen that the colorant is dried, partly or completely obstructing the outlet hole.

The partial obstruction of the outlet hole can cause, at the subsequent delivery, the flow of colorant fluid to deviate from the trajectory provided, by accumulations of residues of colorant from the previous deliveries.

In the long term, there can also be a complete obstruction of the outlet hole, which causes both the failed delivery of the colorant delivered by the obstructed nozzle, and also the possible damage to components or parts of the delivery head, which must therefore be replaced early, with consequent maintenance and downtime costs.

Furthermore, another disadvantage that can occur at the end of each delivery cycle is that a certain quantity of the freshly delivered colorant can deposit around the colorant outlet hole, thus dirtying the ends of the nozzles.

This is particularly disadvantageous when the nozzle has to deliver a different colorant between one delivery cycle and the next, because the colorant delivered in the next delivery cycle is contaminated by the colorant delivered before, which has deposited around the outlet hole, so that the chromatic result obtained in the next delivery cycle is different from the expected one.

In order to prevent these disadvantages, colorant delivery machines have been developed that are provided with systems to condition and clean the delivery heads.

One example of this type of delivery machine is described in the international patent application WO 2003/082728, property of the same Applicant.

This document describes a delivery machine provided with a conditioning and cleaning system which comprises a closed chamber which is mobile along suitable guides to be taken into an operating position such as to enclose the delivery head between one delivery cycle and the next. The closed chamber is a pressurizable chamber into which a pressurized cleaning fluid is introduced.

One disadvantage of this known solution is that the closed chamber, mobile on guides, and the circuit for the circulation of the pressurized cleaning fluid make the machine much more complex and expensive.

Another disadvantage of this known solution is that each cleaning cycle requires long times, which puts limits on the productivity of the colorant delivery machine.

The state of the art also comprises other solutions, such as for example that described in U.S. Pat. No. 5.524.656.

This document describes a device for cleaning colorant delivery heads provided with a plurality of holes configured to be passed through by a cleaning fluid. The device is mobile so as to be moved close to the delivery head.

One disadvantage of this technical solution is that it does not allow effective cleaning of the delivery nozzles.

Another disadvantage of the solution described in this document is that, the longer the washing cycle during which the device cooperates with the delivery head to clean the nozzles, the greater the precision of the cleaning. It is evident that this makes this system not suitable to be integrated into delivery machines for industrial use because it significantly limits productivity.

Other known solutions are described in the prior art patent documents CN 103506238 and KR 10201613352, relating to apparatuses and methods for cleaning working tools. Both of these documents, relating to sectors other than that of machines for delivering colorant fluid products, provide a system suitable for spraying the zone to be cleaned with a cleaning fluid (liquid in one case and aeriform in the other). In one version, both documents provide that the cleaning fluid is shaken or accelerated by a high frequency vibrating ultrasound device.

Since these known solutions do not provide a closed receptacle suitable to contain the cleaning fluid at least during the cleaning step, these solutions are disadvantageous because the cleaning fluid is dispersed, dirtying the vicinity, and causing a considerable waste of fluid. In use, these solutions are therefore expensive and do not respect the environment as they consume large quantities of natural resources (water or air) used as cleaning fluid. Moreover, these solutions are disadvantageous because long and laborious operations for cleaning the apparatuses are frequently required.

One purpose of the present invention is to make available a cleaning device and a corresponding method for cleaning one or more delivery elements of colorant fluid products able to clean the delivery nozzles effectively.

Another purpose of the present invention is to make available a cleaning device and a corresponding method for cleaning one or more delivery elements of colorant fluid products which allows to remove the dried colorant product which partly or completely obstructs the outlet hole of the fluid product from the respective nozzle.

Another purpose of the present invention is to make available a device for cleaning one or more delivery elements of colorant fluid products which is constructively simple and economical.

Another purpose of the present invention is to perfect a method for cleaning one or more delivery elements of colorant fluid products that is reliable and easy to implement.

Another purpose of the present invention is to make available a delivery machine for colorant fluid products comprising the above cleaning device.

Another purpose of the present invention is to make available a delivery machine in which the cleaning cycles have a shorter duration than the cleaning cycles of known solutions, so that the cleaning cycles do not significantly reduce the productivity of the machine.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, according to the invention, a cleaning device is made available, comprising a washing receptacle configured to receive a washing fluid, and movement means configured to move the washing receptacle at least between a cleaning position, in which it is disposed in proximity to the elements to be cleaned in a position such that they are at least partly immersed in the washing fluid, and an inactive position, in which it is distant from the elements to be cleaned in a position at least non-interfering with the delivery cycle.

According to one aspect of the present invention, the cleaning device comprises vibrating means disposed in proximity to at least one of the walls of the washing receptacle and activation means to activate the vibrating means, configured to make the latter vibrate at high frequency so as to generate mechanical energy to be transferred to the washing fluid.

Thanks to the high frequency vibrating means, in the cleaning device according to the invention the washing fluid is advantageously able to perform washing cycles having an effectiveness that is much higher than that of the washing cycles carried out with jets of nebulized fluid or jets of high pressure fluid, such as those used in systems known in the state of the art.

Advantageously, the vibrations of the vibrating means allow to move the washing fluid contained in the washing receptacle in a turbulent motion.

Another advantage obtainable thanks to the vibrating means is that cavitation is generated. Thanks to cavitation, many microscopic steam-filled bubbles are formed in the washing fluid on the one hand, and on the other hand implode, in a rapid and continuous way.

Advantageously, the mechanical action of the shock waves caused by the implosions of the bubbles allows to remove the dirt or impurities present on the elements to be cleaned.

By way of non-restrictive example, a cleaning device according to the present invention can be advantageously used to clean the terminations of elements or nozzles for delivering a colorant fluid product.

In one embodiment, the vibrating means comprise a piezoelectric transducer configured to vibrate at frequencies between 20 and 50 KHz.

Thanks to these very high frequencies of vibration, the cleaning device is able to perform an effective cleaning in an extremely short time. This reduces the duration of the washing cycles and consequently reduces the downtimes or unproductive times of the machine with which the cleaning device can be associated.

Another advantage deriving from the use of vibrating means according to the invention is that they are very compact and economical.

In one embodiment, the washing fluid is water.

In an alternative embodiment, the washing fluid comprises water and one or more solvents, known in the state of the art, for the purpose of increasing the cleaning action of the washing fluid.

In one embodiment, the vibrating means are disposed below the base wall of the washing receptacle, in contact with the latter.

In one embodiment, the movement means comprises a cam-tappet mechanism which is conformed in such a way as to move the washing receptacle in a combined rotation and translation movement.

Advantageously, the movement means allow to move the washing receptacle quickly and reliably in such a way as to quickly free the area, below the elements that have been cleaned.

In one embodiment, the movement means comprise a support arm to support the washing receptacle, provided with attachment means which allow the cleaning device to be connected to a machine or to an apparatus comprising the elements to be cleaned.

In one embodiment, the cleaning device comprises a level sensor associated with a lateral wall of the washing receptacle to detect the level reached inside the latter by the washing fluid.

In an alternative embodiment, a level sensor is provided which is not comprised in the cleaning device, but is instead associated with the elements to be cleaned. By way of example, the level sensor can be located between the elements to be cleaned, because even in this position it is able to detect the level reached by the washing fluid when the elements to be cleaned (and with them the level sensor) are immersed in the latter.

According to some embodiments, the receptacle is connected to at least one tank for the washing fluid.

In one embodiment, the cleaning device comprises a first collection tank, configured to contain “clean” washing fluid to be sent to the receptacle, and a second collection tank, configured to receive the washing fluid from the washing receptacle, once a cleaning cycle has been completed.

In a variant embodiment, the cleaning device comprises a single collection tank for the washing fluid, both for the fluid that is sent to the washing receptacle, and for the fluid which returns from the latter after the washing cycle, along with the residues of colorant that have been removed from the elements to be cleaned. This variant advantageously allows to reduce the number of components necessary to make the circulation system of the washing fluid function correctly.

According to another aspect of the present invention, a cleaning method is provided, comprising the steps of:
providing a washing receptacle configured to contain a washing fluid,
moving the washing receptacle by means of movement means between an inactive position and a cleaning position, in which the washing receptacle is respectively distant from and in proximity to the elements to be cleaned, so that the latter are at least partly immersed in the washing fluid when the washing receptacle is in the cleaning position,
when the washing receptacle is in the cleaning position, driving, by means of activations means, vibrating means disposed in proximity to at least one of the walls of the washing receptacle and suitable to vibrate at high frequency so as to generate mechanical energy to be transferred to the washing fluid.

In one embodiment, the step of driving the vibrating means provides to make the latter vibrate at a frequency between 20 and 50 KHz for a time interval of 15 to 90 seconds.

According to another aspect of the present invention, a machine for delivering colorant fluid products is provided, comprising a delivery head provided with a plurality of delivery elements or nozzles, each configured to deliver a different colorant fluid product or a mixture of two or more colorant fluid products, and also comprising the cleaning device.

One advantage of the delivery machine according to the present invention is that it guarantees an efficient cleaning of the elements or nozzles for delivering the colorant fluid product by virtue of the cleaning device.

The cleaning of the elements or delivery nozzles allows to remove dirt or impurities accumulated on the terminations of said elements, around the outlet hole of the colorant fluid product. For example, in the delivery machine according to the present invention it is possible to effectively remove residues of colorants delivered in previous delivery cycles which after a certain period of time have dried on the terminations of said elements.

In one embodiment, the delivery machine comprises suitable connection means intended to be connected to the attachment means of the cleaning device in order to connect the latter to the delivery machine.

According to one embodiment, the movement means are disposed in correspondence with the junction between the connection means and the attachment means.

According to a characteristic aspect of another embodiment of the cleaning device according to the present invention, the cleaning device also comprises cleaning means configured to contact the delivery elements at least when the washing receptacle is disposed in the cleaning position to remove any residues of the product delivered by the delivery elements by means of a mechanical action, for example of an abrasive type.

According to a characteristic aspect of a variant embodiment of the method for cleaning delivery elements of a fluid product according to the present invention which uses the embodiment of said cleaning device, the following steps are provided:
taking the washing receptacle to the cleaning position after one or more delivery cycles of the fluid product so that the cleaning means contact the delivery elements to remove any residues of the product delivered by the delivery elements by a mechanical action,
when the washing receptacle is in the cleaning position, driving at predetermined time intervals—for example every n delivery cycles, n being a predetermined number of cycles—the vibrating means suitable to vibrate at high frequency so as to generate mechanical energy to be transferred to the washing fluid.

These and other aspects, characteristics and advantages of the present disclosure will be better understood with reference to the following description, drawings and attached claims. The drawings, which are integrated and form part of the present description, show some embodiments of the present invention, and together with the description, are intended to describe the principles of the disclosure.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematic perspective view from below of an embodiment of a cleaning device for cleaning delivery elements of a colorant fluid product according to the present invention, in which a portion of a delivery machine of the colorant fluid products is visible;

FIGS. 2-4 are lateral, schematic and partly sectioned elevation views of the device and the portion of machine in FIG. 1, in which a sequence of successive operating steps is visible;

FIG. 5 is a partly exploded perspective view of an enlarged detail of the device in FIG. 1;

FIG. 6 is a perspective view from above of the enlarged detail in FIG. 5,

FIGS. 7 and 8 are schematic views of two different embodiments of a plant to make the colorant fluid product circulate in the device in FIG. 1;

FIGS. 9 and 10 are perspective views from above, schematic, of another embodiment of a cleaning device for cleaning the delivery elements of a colorant fluid product according to the present invention, in which a portion of a delivery machine for delivering colorant fluid products is visible, said views showing a cleaning device disposed in two different operating positions;

FIGS. 11 and 12 are cross-sections of the cleaning device in FIGS. 9 and 10, which show the cleaning device respectively in a non-operating position and an operating position;

FIG. 13 is a plan view from above of an enlarged detail comprised in the cleaning device of FIGS. 9 and 10.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

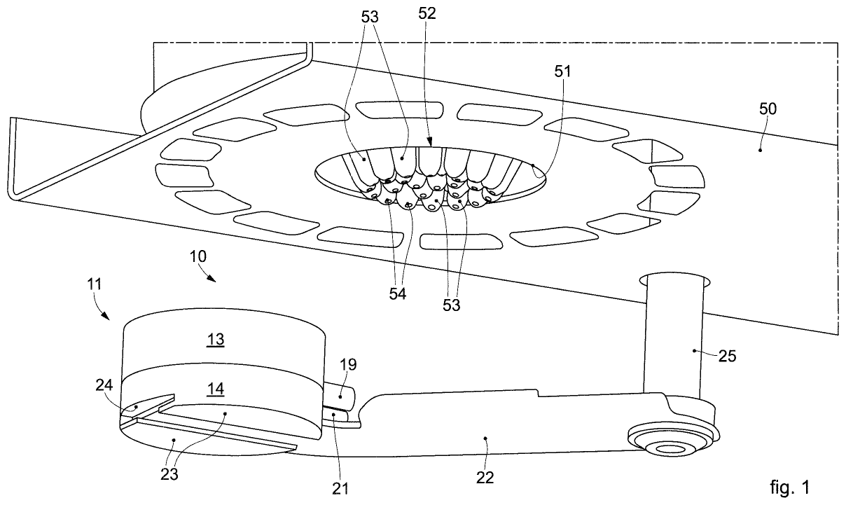

With reference to FIGS. 1-6, we will now describe a first embodiment of a cleaning device, indicated as a whole by the reference number 10.

In the particular embodiment shown, the cleaning device 10 is associated with a delivery machine for colorant fluid products, of which some portions are visible in the attached drawings.

With reference to FIGS. 1-4, a protective casing 50 is visible, suitably shaped starting from a metal sheet, delimiting the delivery machine at the lower part.

The protective casing 50 comprises at least one aperture 51 from which a delivery head 52 protrudes.

The delivery head 52 comprises a plurality of delivery elements 53, or nozzles, each provided with an outlet hole 54 intended to be passed through by the colorant and selectively reclosable by means of a suitable closing valve (not shown).

The delivery elements 53 are of a type known in the state of the art and will not be described here in detail. By way of non-restrictive example, the delivery elements 53 can be of the type with miniaturized valve terminations, close together and collected in a central nozzle position, and which close at the end of the delivery cycle.

However, it is understood that the cleaning device 10 according to the invention can also be associated, with equal effectiveness and reliability, and obtaining all the connected advantages, with other types of machines or apparatuses interacting with fluid products and comprising elements which during use become dirty and must be cleaned periodically, for example between one work cycle and the next.

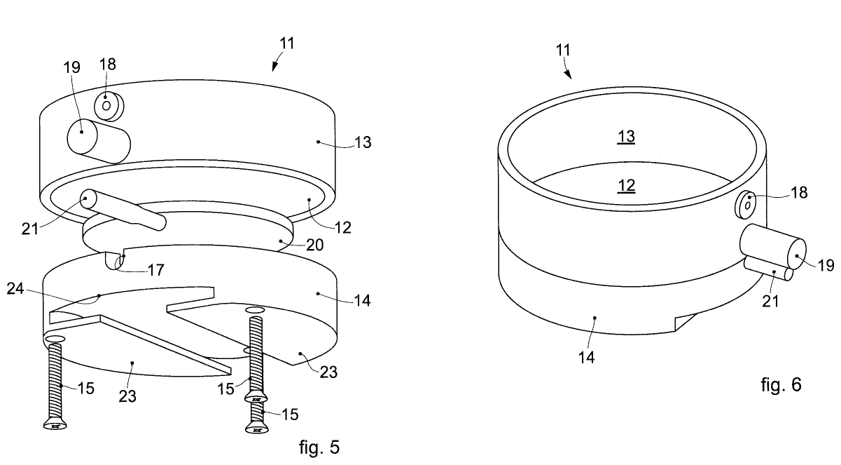

The cleaning device 10 comprises a washing receptacle 11, better seen in FIGS. 5 and 6.

The washing receptacle 11 defines a container configured to be filled with washing fluid 100.

In one embodiment, the washing receptacle 11 has a cylindrical shape and comprises a base wall 12 and a lateral wall 13.

It is understood that the shape can also be different from cylindrical, provided it is suitable to cooperate with the specific nozzle group of the delivery machine.

In one embodiment, the cleaning device 10 comprises a support base 14 on which the washing receptacle 11 rests.

According to some embodiments, the support base 14 is cylindrical and substantially has the same diameter as the washing receptacle 11.

In a preferred embodiment, the washing receptacle 11 is connected to the support base 14 by a mechanical connection, for example by means of one or more threaded screws 15.

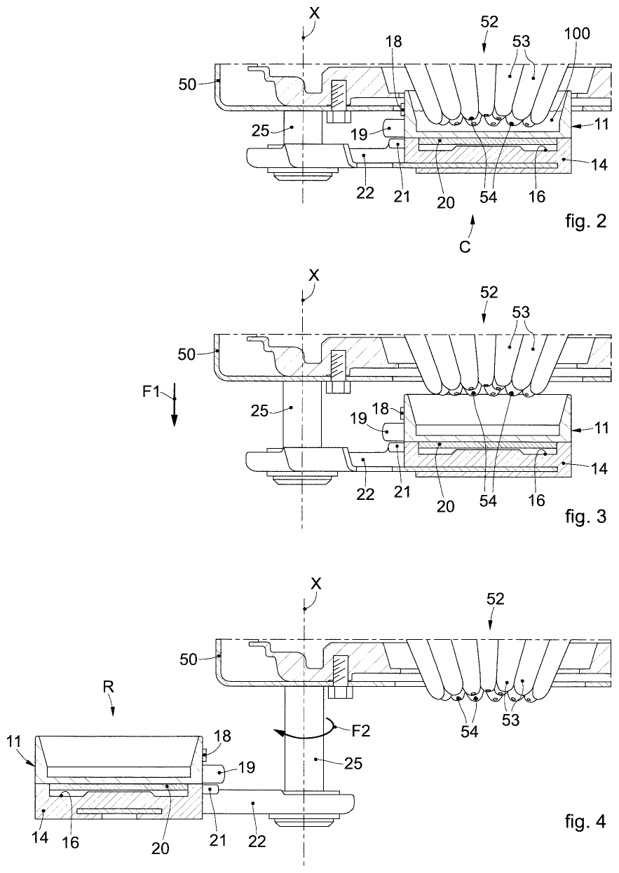

In some embodiments, between the washing receptacle 11 and the support base 14 a seating 16 is defined, visible in FIGS. 2-4.

In an alternative embodiment, the washing receptacle 11 and the support base 14 are integrated in a single body. In this version too, an internal seating is defined, similar to the seating 16 shown in the attached drawings.

The cleaning device 10 comprises a piezoelectric transducer 20, for example shaped like a disk made of ceramic material.

In one embodiment, the piezoelectric transducer 20 is housed in the seating 16 and is disposed below the base wall 12, and in contact therewith.

In a preferred embodiment, the piezoelectric transducer 20 is disposed in its seating 16 and is glued below the base wall 12 through the use of a suitable high resistance adhesive substance, of a type known in the state of the art.

The piezoelectric transducer 20 is configured to vibrate at high or very high frequencies, for example at frequencies comprised between 20 KHz and 50 KHz.

The cleaning device 10 also comprises a supply cable 21 which is connected to the piezoelectric transducer 20 in order to activate it and make it vibrate.

In one embodiment, the support base 14 is provided with a hole 17 configured to allow passage of the supply cable 21.

According to one embodiment, the cleaning device 10 comprises a level sensor 18 configured to detect the level reached by the washing fluid 100 in the washing receptacle 11. The level sensor 18 can be a type known in the state of the art, for example the type that detects the conductivity of the washing fluid 100 to measure the level thereof.

It should be noted that the level sensor 18 is constrained to the lateral wall 13, at a predetermined distance from the base wall 12.

In an alternative embodiment (not shown), the level sensor 18 is not attached to the lateral wall 13, but is instead associated with the delivery elements 53. For example, the level sensor 18 can be disposed in a substantially vertical direction, approximately at the center of the group of delivery elements 53 in a position such as to be aligned with the terminations of the latter.

In some embodiments, the cleaning device 10 comprises a connection joint 19 which connects the inside of the washing receptacle 11 with a passage pipe (not shown) for the washing fluid 100.

According to some embodiments, the cleaning device 10 also comprises movement members to move the washing receptacle 11 between a cleaning position C and an inactive position R.

In one embodiment, the movement members comprise a cam-tappet mechanism.

According to some embodiments, the movement members comprise a mobile arm 22 which supports the washing receptacle 11. In particular, the mobile arm 22 supports the assembly formed by the washing receptacle 11 and the support base 14.

In one embodiment, the support base 14 comprises coupling elements 23, for example configured as opposite fins that protrude from the bottom of the support base 14 so as to define a groove 24 inside which a terminal end of the mobile arm 22 can be inserted.

In one embodiment, the movement members comprise a shaft 25, which can be connected to a machine or apparatus, such as for example said machine for delivering colorant fluid products. The mobile arm 22 is rigidly constrained to the shaft 25 and is supported cantilevered by the latter.

In one embodiment, the shaft 25 extends vertically in a symmetrical manner around its axis of development X, while the mobile atm 22 is connected to the shaft 25 so as to extend horizontally, starting from the latter. In other words, the mobile arm 22 and the shaft 25 are disposed orthogonally with respect to each other.

The shaft 25 allows to couple the cleaning device 10 with the machine, and is configured to engage with corresponding connection means (not shown in this embodiment) provided on the machine.

In some embodiments, the movement members are configured in such a way as to move the washing receptacle 11 according to a translation movement (indicated by the arrow F1 in FIG. 3) and a rotation movement (indicated by the arrow F2 in FIG. 4). It should be noted that the translation and rotation movements can be sequential one with respect to the other, or simultaneous, or a combined sequence of motion can be provided which envisages both cases. In this embodiment, rotation occurs around the axis of development X and translation occurs along this same axis.

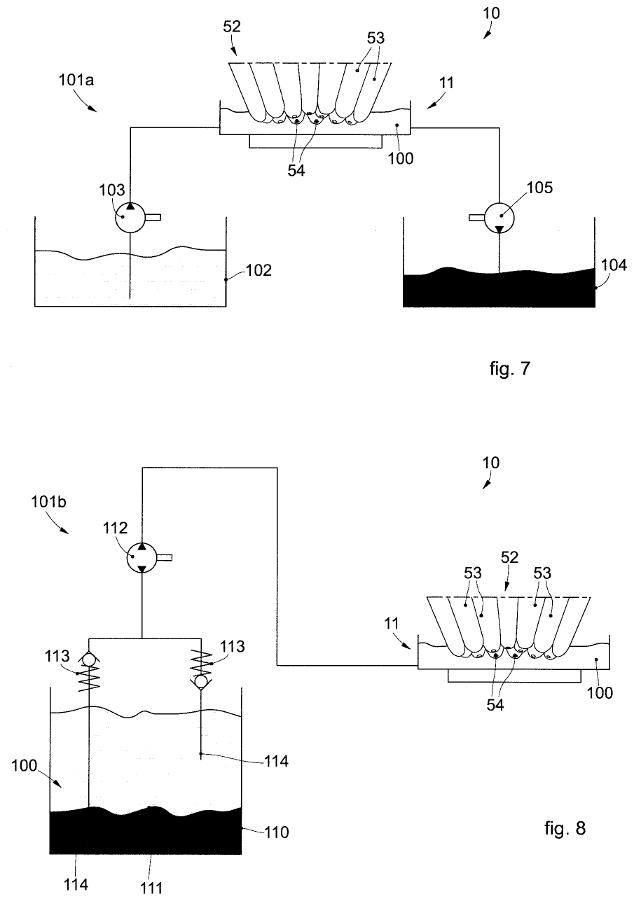

With particular reference to FIGS. 7 and 8, two variant embodiments of a plant 101a, 101b are visible for the circulation of the washing fluid 100.

According to a first embodiment (FIG. 7), the plant 101a comprises a first tank 102 intended to receive the “clean” washing fluid 100 which has to be sent to the washing receptacle 11. A first pump 103 is associated with the first tank 102, and is a type known in the state of the art, which removes the washing fluid 100 from the first tank 102 to send it toward the washing receptacle 11.

In this embodiment, the plant 101a comprises a second tank 104 intended to receive the “used” washing fluid 100 that exits from the washing receptacle 11. A second pump 105 is associated with the second tank 104, and is a type known in the state of the art, which removes the washing fluid 100 from the washing receptacle 11 to send it toward the second tank 104.

According to a second embodiment (FIG. 8), the plant 101b comprises a single tank 110 intended to receive both the “clean” washing fluid 100 which has to be sent to the washing receptacle 11, and also the “used” washing fluid 100 exiting from the washing receptacle 11.

In this embodiment, it is provided to use chemical additives, of the known type, which allow to obtain a reaction that allows to thrust the colorant residues removed from the elements that have been cleaned toward the bottom of the tank 110, thus separating the residues of dirt from the “clean” washing fluid still to be used. In FIG. 8 a schematic separation line 111 indicates the separation between the washing fluid 100 and the residues.

In this variant, the plant 101b comprises a pumping member 112, of the reversible type, which is configured to remove the washing fluid 100 from the tank 110 so as to send it toward the washing receptacle 11, and vice versa.

The system 101b also comprises a pair of non-return valves 113, each disposed on a respective pipe 114, and suitably oriented so as to prevent unwanted refluxes of fluid toward the tank 110 and the washing receptacle 11, respectively.

The cleaning device 10 according to the invention operates in the manner described below.

When a cleaning cycle of the delivery elements 53 is to be performed, the shaft 25 and the arm 22 move in a roto-translational movement around and along the axis of development X to take the washing receptacle 11 from the inactive position R to the cleaning position C.

In the cleaning position C, the terminations of the delivery elements 53 and the outlet holes 54 of the colorant fluid product are disposed inside the washing receptacle 11, which in the meantime is filled with the washing fluid 100 coming from the tank 102, 110. In this way, the terminations of the delivery elements 53 are immersed in the washing fluid.

It should be noted that, in some embodiments provided here, the washing receptacle 11 is conformed in such a manner as to define a closed container in cooperation with parts of the delivery machine, for example with the protective casing 50, at least when the washing receptacle 11 is in the cleaning position C. In a particular embodiment, the lateral wall 13 of the washing receptacle 11 is conformed so that, when the washing receptacle 11 is in the cleaning position C, its upper edge is substantially flush with the aperture 51 made in the protective casing 50, or protrudes above the latter, as shown in FIG. 2. In this way, the lateral wall 13 surrounds the delivery head 52 and encloses it inside a closed space defined by the washing receptacle 11, filled with the cleaning fluid, in cooperation with the protective casing 50. This embodiment advantageously allows to keep the zone surrounding the delivery head 52 clean, preventing splashes of the cleaning fluid and/or the colorant removed from the delivery elements 53 from dirtying the vicinity.

It is then provided to activate the piezoelectric transducer 20 for a predetermined period of time so as to put it in high-frequency vibration.

The vibration of the piezoelectric transducer 20 causes the phenomenon of cavitation in the washing fluid 100, where very many microscopic vapor bubbles are generated and implode in a rapid and continuous manner. The cavitation generates mechanical impacts of the bubbles against the delivery elements 53, thus removing the residues of colorant, impurities and dirt present on them.

Once the cleaning cycle is terminated, the washing receptacle 11 is emptied and the washing fluid 100, together with the residues removed, is sent toward the tank 104, 110 by the pumping members 105, 112.

The washing receptacle 11 is then moved away from the delivery elements 53 and returned to the inactive position R.

It should be noted that the cleaning cycle can be performed after each delivery cycle of the colorant fluid product by the delivery elements 53, or at regular and predetermined time intervals. In the latter case, between one cleaning cycle and the next one, numerous delivery cycles of the colorant fluid product can also be performed.

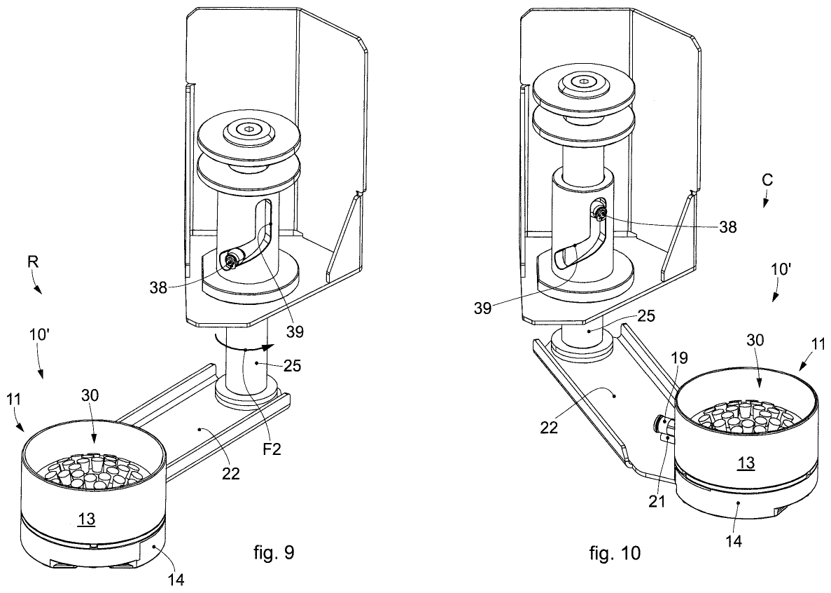

With reference to FIGS. 9-13, we will now describe another embodiment of a cleaning device according to the present invention, indicated in its entirety by the reference number 10′.

The parts of the cleaning device 10′ similar to those of the cleaning device 10 described above will be identified by the same reference numbers and will not be described again in detail.

In this embodiment, the cleaning device 10′ comprises a cleaning member 30.

In the embodiment described here and shown in FIGS. 9-13 the cleaning member 30 is configured as a brush.

In other embodiments, not shown, the cleaning member can be configured as a sponge, or as a deformable element, for example made of silicone materials or other suitable plastic materials, in both cases being elements that are entirely equivalent to the brush described below. These elements will naturally be free of bristles but can be shaped similarly to the brush, having for example the same curvilinear profile, or a hemispherical cap.

The cleaning member 30 comprises a support element 31 and a plurality of bristles 32.

In one embodiment, the support element 31 comprises a surface 34 on which a plurality of seatings 33 are made, in order to attach the bristles 32, according to methods known in the state of the art.

In a preferred embodiment, the surface 34, or the surface of the support element 31 facing toward the delivery elements 53, has a curvilinear profile, being for example shaped like a dome or a hemispherical cap.

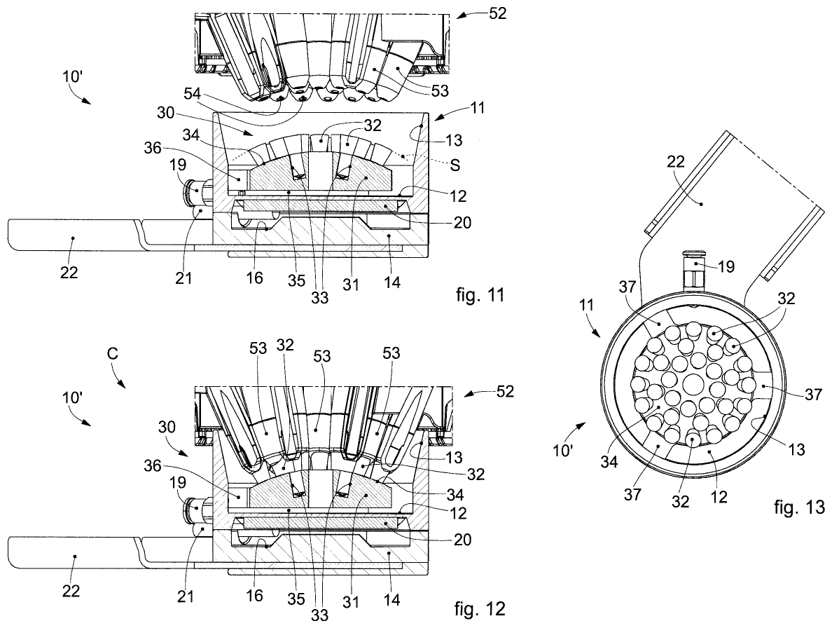

According to some embodiments provided here, the bristles 32 are homogeneously distributed on the surface 34 so as to define a top profile S (indicated by the broken line in FIG. 11) of the cleaning member 30 which is correlated to the shape and position of the assembly of delivery elements 53. It is evident that the profile of the top profile S is a function both of the curvature of the surface 34 and of the length of the bristles 32 and also their disposition thereon.

According to some embodiments, the cleaning member 30 is supported by the lateral wall 13 of the washing receptacle 11 so as to be raised with respect to the base wall 12 of the latter so as to define an interspace 35 which develops between the element support 31 and the base wall 12.

It should be noted that the presence of the interspace 35 facilitates the circulation of the washing fluid inside the washing receptacle 11. In this way, the presence of the cleaning member 30 does not prevent the flow of the washing fluid from passing, guaranteeing the correct functioning of the cleaner device 10′.

According to some embodiments, the cleaning member 30 is supported by the lateral wall 13 by means of mechanical connection members 36, such as pins, screws, or interlocking or snap-in connections of elements coupled according to same-shape coupling.

In the version shown, the mechanical connection means 36 are configured to allow clamping/disassembling respectively to constrain or release the support element 31 to/from the lateral wall 13 of the washing receptacle 11.

In a preferred embodiment, the support element 31 and the lateral wall 13 are joined in correspondence with three constraint points, angularly distanced by about 120° with respect to each other, as shown in FIG. 13.

In some embodiments, the cleaning member 30 can comprise one or more protruding portions 37 (FIG. 13), which protrude radially toward the outside, that is, toward the lateral wall 13, at least in correspondence with the constraint points in correspondence with which it is attached to the latter. In the example shown in the drawings, there are three protruding portions 37, angularly distanced by about 120° with respect to each other, each of which houses a respective mechanical connection element 36.

In the embodiment described here and shown in FIGS. 9-13 the cleaning member 30 is fixed with respect to the washing receptacle 11.

In other embodiments provided here, but not shown, the cleaning member 30 can be equipped with drive means (for example electric or mechanical), which allow the rotation or oscillation thereof around a central axis of symmetry of the cleaning member 30. It is obvious that, in this case, the mechanical connection means 36 must be suitable to constrain the support element 31 to the lateral wall 13 so as to allow movement of the cleaning member 30 with respect to the washing receptacle 11. For example, in this embodiment, guide grooves can be provided on the lateral wall 13, inside which support pins associated with the support element engage.

Also in this embodiment of the cleaning device 10′, like the one described previously, the washing receptacle 11 is mobile between the inactive position R (FIG. 9) and the cleaning position C (FIGS. 10 and 12) according to a roto-translational movement of the assembly formed by the shaft 25 and the mobile arm 22. As can be seen in FIGS. 9 and 10, the roto-translational movement can be commanded by a cam system, in which it is provided to drive a guide pin, or tappet pin 38, configured to slide inside a shaped groove 39 which acts as a cam. It should be noted that FIG. 11 shows an intermediate operating condition between the inactive position R and the cleaning position C, in which the washing receptacle 11 is already aligned below the delivery head 52, for example after having completed the rotation movement and before performing the translation movement (lifting) upward.

The cleaning method to clean the delivery elements 53 using the cleaning device 10′ provides to take the washing receptacle 11 to the cleaning position C after each delivery cycle of the fluid product.

In other embodiments, it is provided to take the washing receptacle 11 to the cleaning position C after a certain predetermined number of delivery cycles of the fluid product, for example every two, or five, or ten delivery cycles of the fluid product.

In both these cases, the washing receptacle 11, when it is in the cleaning position C, can be filled, or not, with the washing fluid; if there is no fluid, the cleaning action is carried out exclusively by the cleaning member 30.

As shown in FIG. 12, in the cleaning position C, the cleaning member 30 is in contact with the delivery elements 53, in particular with the terminations thereof, that is the zone where residues of the delivered fluid product can be deposited.

During the movement of the cleaning member 30 toward/away from the delivery elements 53, the relative movement between them causes the removal of possible residues of the product delivered by the delivery elements 53 thanks to the mechanical action of sliding abrasion exerted by the bristles 32.

The cleaning method also provides to fill the washing receptacle 11 with the washing fluid at predetermined time intervals—in particular after a certain number n of delivery cycles—and to fill the receptacle with washing fluid, and then drive the piezoelectric transducer 20 in the manner explained above.

For example, a cleaning cycle can be provided where the washing receptacle 11 is filled and the piezoelectric transducer 20 is driven once a day, or every two days, or once a week. Consequently, the cleaning cycle where the washing receptacle 11 is filled and the piezoelectric transducer 20 is driven can also be performed after many delivery cycles of the colorant fluid product, for example a number in the order of a few dozen delivery cycles.

According to this variant of the cleaning method using the cleaning device 10′, the piezoelectric transducer 20 can be made to vibrate at high or very high frequencies, for example comprised between 20 KHz and 50 KHz for a few minutes, for example for about 3-5 minutes. It should be noted that in this variant the piezoelectric transducer 20 is driven for a longer time since given that the cleaning cycle with the piezoelectric transducer 20 is not performed after each delivery cycle but only occasionally—its duration does not significantly impact the productivity of the delivery machine with which the cleaning device 10′ is associated, but a more effective cleaning is obtained because the cleaning action in this case is proportional to the time the piezoelectric transducer 20 is driven.

This embodiment of the cleaning device 10′ therefore advantageously allows to save on the consumption of the washing fluid (for example water) since the cleaning operation by driving the piezoelectric transducer 20 is only occasional and not after every delivery cycle. The saving on fluid consumption naturally translates into both an economic saving on management costs connected to the functioning of the cleaner 10′, and also a lower environmental impact thanks to reduced water consumption.

According to one implementation of the method according to the present invention, a cleaning cycle of the cleaning member 30 can be provided, when the washing receptacle 11 is in the inactive position R. According to this version, when the washing receptacle 11 is in the inactive position R (FIG. 9), it is provided to fill it with the washing fluid and subsequently to drive the piezoelectric transducer 20. This can be performed at predetermined time frequencies, for example one or more times a day, or every two days, or once a week. Thanks to the action of the piezoelectric transducer 20 it is possible, advantageously, to clean the cleaning member 30—on which colorant residues removed from the delivery elements 53 are deposited—automatically, without the operator having to intervene to manually wash the cleaning member 30, or even to replace it. Furthermore, the cleaning member 30 can be cleaned advantageously while the delivery machine with which the cleaning device 10′ is associated is delivering the colorant fluid product since, given that it takes place in the inactive position R, the washing receptacle 11 in this position is not disposed below the delivery head 52, which can thus perform the delivery cycle provided.

It is clear that modifications and/or additions of parts or steps can be made to the device and/or method as described heretofore, without departing from the field and scope of the present invention.

It is also clear that, although the present invention has been described with reference to some specific examples, a person of skill in the art shall certainly be able to achieve many other equivalent forms of devices and methods, having the characteristics as set forth in the claims and hence all coming within the field of protection defined thereby.

1. Cleaning device to clean fluid product delivery elements, comprising a washing receptacle configured to receive a washing fluid and provided with walls so as to define a container configured to be filled with the washing fluid, and movement means configured to move said washing receptacle at least between a cleaning position, in which said washing receptacle is disposed in proximity to said delivery elements to be cleaned in a position such that said delivery elements are at least partly immersed in said washing fluid, and an inactive position, in which said washing receptacle is distanced from said delivery elements, said cleaning device being characterized in that it comprises vibrating means disposed in proximity to at least one of said walls, and activation means to activate said vibrating means, configured to make the latter vibrate at high frequency so as to generate mechanical energy to be transferred to said washing fluid.

2. Device as in claim 1, characterized in that said vibrating means comprise a piezo-electric transducer.

3. Device as in claim 1, characterized in that said walls comprise a base wall and a lateral wall, said vibrating means being disposed below said base wall and in contact with said base wall.

4. Device as in claim 1, characterized in that it comprises at least a tank for the washing fluid in fluid connection with said washing receptacle, and pumping means configured to pump said washing fluid from said tank to said washing receptacle, and vice versa.

5. Device as in claim 1, characterized in that said movement means comprise a support arm rigidly constrained to a shaft configured to be associated with a delivery machine comprising said delivery elements.

6. Device as in claim 1, characterized in that said movement means comprise a cam-tappet mechanism suitable to move said washing receptacle according to a combined movement of rotation and translation.

7. Device as in claim 1, characterized in that said washing receptacle is conformed so as to define a closed container in cooperation with parts of said delivery machine, for example with a protective casing, at least when said washing receptacle is in said cleaning position.

8. Device as in claim 3, characterized in that said lateral wall is conformed so that, when said washing receptacle in said cleaning position, an upper edge thereof is substantially flush with an aperture made in said protective casing, or protrudes above the latter.

9. Device as in claim 1, characterized in that it also comprises cleaning means configured to contact said delivery elements at least when said washing receptacle is disposed in said cleaning position to remove any residues of the product delivered by said delivery elements by means of a mechanical action.

10. Device as in claim 9, characterized in that said cleaning means comprise a support element and a plurality of bristles attached in corresponding seatings made on a surface of said support element which faces toward said delivery elements.

11. Device as in claim 10, characterized in that said walls comprise a base wall and a lateral wall, said cleaning means being supported by said lateral wall so as to be raised with respect to said base wall so as to define an interspace which develops between said support element and said base wall.

12. Device as in claim 10, characterized in that said bristles are homogeneously distributed on said surface so as to define a top profile of said cleaning means correlated to the shape and to the position of the assembly of said delivery elements to be cleaned.

13. Device as in claim 9, characterized in that said cleaning means are attached to said lateral wall by one or more mechanical connection means.

14. Device as in claim 9, characterized in that said cleaning means comprise a sponge, or a deformable element, in particular made of silicone materials or other suitable plastic materials.

15. Cleaning method to clean fluid product delivery elements, comprising the steps of:
providing a washing receptacle suitable to contain a washing fluid and provided with walls so as to define a container configured to be filled with the washing fluid,
moving the washing receptacle by means of movement means between an inactive position and a cleaning position, in which said washing receptacle is respectively distant from and in proximity to said delivery elements, so that the latter are at least partly immersed in said washing fluid when said washing receptacle is in said cleaning position,
when said washing receptacle is in said cleaning position, driving, by means of activations means, vibrating means disposed in proximity to at least one of said walls and suitable to vibrate at high frequency so as to generate mechanical energy to be transferred to said washing fluid, said drive being carried out in particular at pre-established time frequencies, for example after a certain number n of delivery cycles.

16. Method as in claim 15, characterized in that said vibrating means vibrate at a frequency comprised between 20 and 50 KHz for a period of time comprised between 15 and 90 seconds.

17. Method as in claim 15, characterized in that said step of driving said vibrating means has a fixed duration in time and is carried out after each delivery cycle of said colorant fluid product, or after a plurality of delivery cycles of said colorant fluid product, by said delivery elements.

18. Method as in claim 15, characterized in that after one or more delivery cycles of said fluid product it is provided to take said washing receptacle into said cleaning position so that said cleaning means disposed inside said washing receptacle and supported by at least one of said walls contact said delivery elements to remove any possible residues of the product delivered by said delivery elements by means of a mechanical action.

19. Machine to deliver a colorant fluid product, comprising a delivery head provided with one or more delivery elements of said colorant fluid product, and characterized in that it comprises a cleaning device as in claim 1.
